(19) United States
(12) Patent Application Publication
(10) Pub. No.: US 2025/0279619 A1
(43) Pub. Date: Sep. 4, 2025

(54) CONNECTOR AND WIRING HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Jisung KIM, Mie (JP); Naoya HAMAMOTO, Mie (JP)

(21) Appl. No.: 18/859,173

(22) PCT Filed: Apr. 21, 2023
(86) PCT No.: PCT/JP2023/016001

§ 371 Date: Oct. 23, 2024

(30) Foreign Application Priority Data
May 2, 2022 (JP) 2022-076089

(51) Int. Cl. H01R 13/73; H01B 7/00; H01R 4/20; H01R 13/52; H01R 13/6592

(52) U.S. Cl. CPC H01R 13/73; H01B 7/0045; H01R 4/20; H01R 13/5202; H01R 13/6592

(57) ABSTRACT

A connector (30) electrically connects a shield member to a mounting object by being fixed to an end part of a shielded cable (20) including a core wire (23), an insulation coating (24) covering an outer periphery of the core wire and the shield member (22) for covering an outer periphery of the insulation coating and fixed to the mounting object. The connector includes a metal pipe (31), through which the core wire and the insulation coating are passed and to which the shield member is connected, and a metal fixing member (32) to be fixed to an outer peripheral surface of the metal pipe and fixed to the mounting object.

### TECHNICAL FIELD

The present disclosure relates to a connector and a wiring harness.

### BACKGROUND

Conventionally, a wiring harness is known which is provided with a shielded cable and a connector fixed to an end part of the shielded cable (see, for example, Patent Document 1). The connector disclosed in Patent Document 1 includes a resin housing and a metal shell covering the outside of the resin housing and to be fixed to a mounting object. A shield member of the shielded cable is connected to the metal shell and electrically connected to the mounting object via the metal shell. In this way, the emission of electromagnetic waves from a core wire of the shielded cable is suppressed.

### PRIOR ART DOCUMENT

### Patent Document

Patent Document 1: JP 2020-155306 A

### SUMMARY OF THE INVENTION

### Problems to be Solved

In the above connector, the resin housing, which is a resin molded article, has been necessary. The connector is required to have an easily manufacturable structure.

The present disclosure aims to provide easily manufacturable connector and wiring harness.

### Means to Solve the Problem

A connector of the present disclosure is for electrically connecting a shield member to a mounting object by being fixed to an end part of a shielded cable including a core wire, an insulation coating covering an outer periphery of the core wire and the shield member for covering an outer periphery of the insulation coating and fixed to the mounting object, and provided with a metal pipe, the core wire and the insulation coating being passed through the metal pipe, the shield member being connected to the metal pipe, and a metal fixing member to be fixed to an outer peripheral surface of the metal pipe and fixed to the mounting object.

A wiring harness of the present disclosure is provided with the connector and the shielded cable.

### Effect of the Invention

According to the present disclosure, it is possible to provide easily manufacturable connector and wiring harness.

### BRIEF DESCRIPTION OF THE DRAWINGS

FIG. 1 is a perspective view of a part of a wiring harness in one embodiment.

FIG. 2 is a section of a housing of an electrical device and the wiring harness in the embodiment.

FIG. 3 is a partial exploded perspective view of the wiring harness in the embodiment.

FIG. 4 is an exploded perspective view of the connector in the embodiment.

### DETAILED DESCRIPTION TO EXECUTE THE INVENTION

### Description of Embodiments of Present Disclosure

First, embodiments of the present disclosure are listed and described below.

[1] The connector of the present disclosure is for electrically connecting a shield member to a mounting object by being fixed to an end part of a shielded cable including a core wire, an insulation coating covering an outer periphery of the core wire and the shield member for covering an outer periphery of the insulation coating and fixed to the mounting object, and provided with a metal pipe, the core wire and the insulation coating being passed through the metal pipe, the shield member being connected to the metal pipe, and a metal fixing member to be fixed to an outer peripheral surface of the metal pipe and fixed to the mounting object.

According to this configuration, the shield member is connected to the mounting object via the metal pipe and the metal fixing member while the core wire is covered by the metal pipe. Thus, the emission of electromagnetic waves from the core wire can be suppressed. Here, since the metal pipe and the metal fixing member are separate bodies and fixed to each other after manufacturing, each of these can be easily obtained. The connector of the embodiment does not require a resin molded article such as a resin housing provided in conventional connectors and, consequently, a mold for molding this resin molded article is also not required. Therefore, the connector of the embodiment can be easily manufactured.

[2] Preferably, in [1] described above, the metal fixing member is made of a plate material.

According to this configuration, the metal fixing member can be more easily manufactured as compared to a cast.

[3] Preferably, in [1] or [2] described above, the metal fixing member includes a pipe fitting hole, and the metal pipe includes a first pipe expansion portion to be coupled to an inner surface of the pipe fitting hole.

According to this configuration, since the metal pipe can be coupled to the inner surface of the pipe fixing hole by applying a pipe expansion processing to the metal pipe, a fixing operation is easier as compared to welding.

[4] Preferably, in any one of [1] to [3] described above, a first rubber ring is provided which is externally fit to the metal pipe.

According to this configuration, by interposing the first rubber ring between the outer peripheral surface of the metal pipe and the mounting object, this part can be waterproofed.

[5] Preferably, in [4] described above, the metal pipe includes a first pipe contraction portion, the first rubber ring being externally fit to the first pipe contraction portion.

According to this configuration, a position shift of the first rubber ring along a length direction of the metal pipe is suppressed.

[6] Preferably, in any one of [1] to [5] described above, a second rubber ring is provided which is fit into the metal pipe.

According to this configuration, by interposing the second rubber ring between the inner peripheral surface of the metal pipe and the outer peripheral surface of the insulation coating, this part can be waterproofed.

[7] Preferably, in [6] described above, the metal pipe includes a second pipe expansion portion, the second rubber ring being fit into the second pipe contraction portion.

According to this configuration, a position shift of the second rubber ring along the length direction of the metal pipe is suppressed.

[8] Preferably, in any one of [1] to [7] described above, the metal pipe includes a second pipe contraction portion to be pressed into contact with the insulation coating.

According to this configuration, the insulation coating and the connector can be fixed by the second pipe contraction portion without using a separate member.

[9] Preferably, in any one of [1] to [8] described above, the shielded cable is a multi-core collective shielded cable including a plurality of the core wires and a plurality of the insulation coatings, the shield member collectively covering the plurality of insulation coatings, a plurality of the metal pipes are provided, a set of the core wire and the insulation coating being passed through each metal pipe, the metal fixing member is so fixed to at least one of the plurality of metal pipes that axes of the plurality of metal pipes are parallel to each other, and a connecting member is provided to fill up gaps between outer peripheral surfaces of the plurality of metal pipes, the shield member being connected to the connecting member.

According to this configuration, the shield member in the multi-core collective shielded cable can be satisfactorily electrically connected to the metal pipes by the connecting member. That is, in a configuration in which the connecting member is not provided, a contact area is small since the shield member is not in contact with or difficult to contact the plurality of metal pipes in the gaps between the outer peripheral surfaces of the plurality of metal pipes. However, this can be avoided in the above configuration.

[10] Preferably, in [7] described above, the shielded cable is a multi-core collective shielded cable including a plurality of the core wires and a plurality of the insulation coatings, the shield member collectively covering the plurality of insulation coatings, a plurality of the metal pipes are provided, a set of the core wire and the insulation coating being passed through each metal pipe, the metal fixing member is so fixed to at least one of the plurality of metal pipes that axes of the plurality of metal pipes are parallel to each other, and a connecting member is provided to fill up gaps between outer peripheral surfaces of the second pipe expansion portions in the plurality of metal pipes, the shield member being connected to the connecting member.

According to this configuration, in addition to functions and effects of [9], the material cost of the connecting member provided to fill up the gaps can be reduced since the gaps between the outer peripheral surfaces of the second pipe expansion portions are smaller than gaps between the outer peripheral surfaces of other parts, to which the pipe expansion processing is not applied.

[11] The wiring harness of the present disclosure is provided with the connector of any one of [1] to described above and the shielded cable.

According to this configuration, functions and effects similar to those of the connector are obtained.

[12] The wiring harness is provided with the connector of [9] or described above, the shielded cable, and a crimping member for fixing the shield member to the connecting member by being crimped.

According to this configuration, in addition to functions and effects of [11], the shield member can be easily connected to the connecting member by the crimping member.

### DETAILS OF EMBODIMENTS OF PRESENT DISCLOSURE

A specific example of a wiring harness of the present disclosure is described below with reference to the drawings. For the convenience of description, some components may be shown in an exaggerated or simplified manner in each drawing. Further, a dimension ratio of each part may be different in each drawing. “Parallel”, “orthogonal” and “true circular” in this specification mean not only strictly parallel, orthogonal and true circular, but also substantially parallel, orthogonal and true circular within a range in which functions and effects in this embodiment are achieved. Note that the present invention is not limited to these illustrations, but is represented by claims and intended to include all changes in the scope of claims and in the meaning and scope of equivalents.

### (Configuration of Wiring Harness 10)

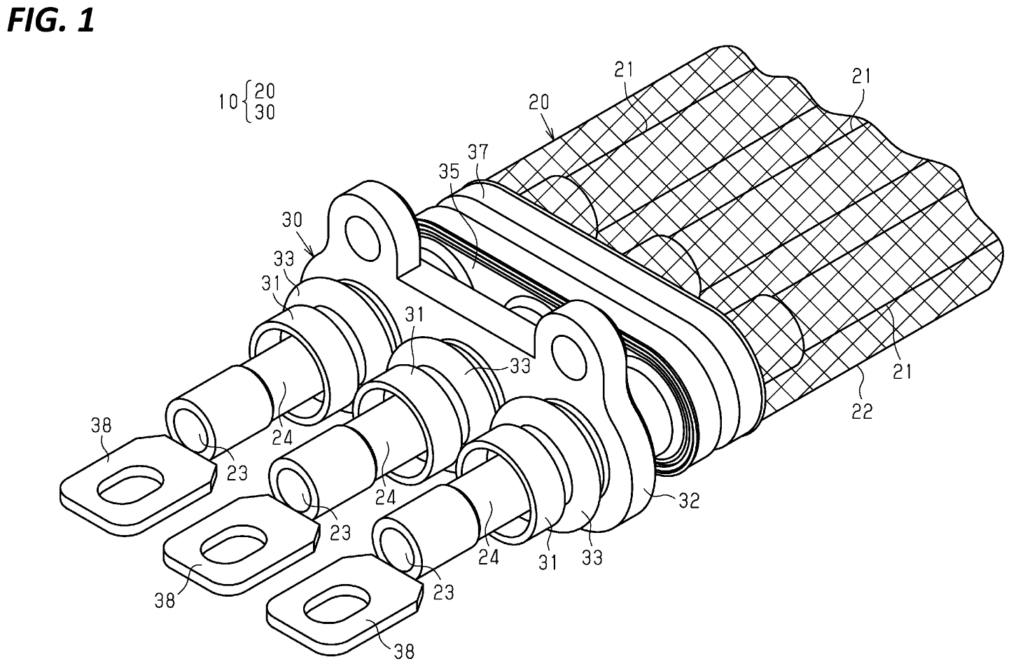

As shown in FIG. 1, a wiring harness 10 is provided with a multi-core collective shielded cable 20 serving as a shielded cable and a connector 30.

### (Configuration of Multi-Core Collective Shielded Cable 20)

As shown in FIGS. 1 to 3, the multi-core collective shielded cable 20 includes wires 21 and a shield member 22. The multi-core collective shielded cable 20 of this embodiment includes three wires 21.

The wire 21 includes a core wire 23 and an insulation coating 24 covering the outer periphery of the core wire 23. The core wire 23 of this embodiment has a circular cross-sectional shape. Further, the insulation coating 24 has an annular cross-sectional shape. The core wire 23 may be made of an electrically conductive material such as metal.

The shield member 22 covers the outer periphery of the insulation coating 24. The shield member 22 of this embodiment collectively covers a plurality of the insulation coatings 24. The shield member 22 is, for example, a braided wire formed by braiding electrically conductive strands of copper alloy, aluminum alloy or the like into a tube. Note that the shield member 22 is schematically shown in each figure. An end part of the wire 21 projects outward from an end part of the shield member 22.

### (Configuration of Connector 30)

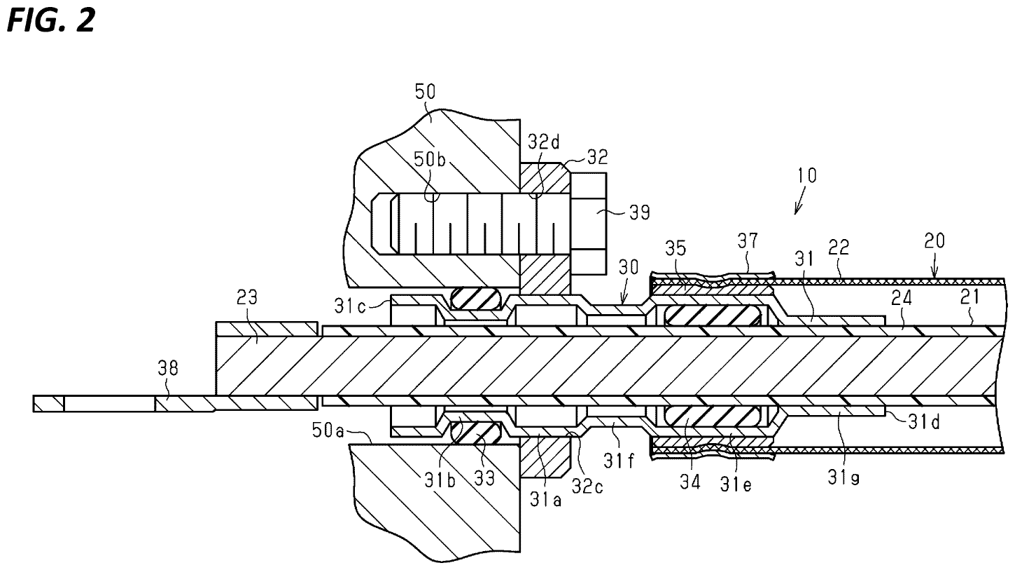

As shown in FIG. 2, the connector 30 is fixed to an end part of the multi-core collective shielded cable 20 and a housing 50 of an electrical device serving as a mounting object.

As shown in FIGS. 1 to 4, the connector 30 is provided with metal pipes 31 and a metal fixing member 32 to be fixed to the outer peripheral surfaces of the metal pipes 31. The connector 30 of this embodiment is provided with three metal pipes 31 corresponding to the three wires 21 of the multi-core collective shielded cable 20. That is, the connector 30 is provided with the three metal pipes 31 and one wire 21 is passed through each metal pipe 31. In other words, a set of the core wire 23 and the insulation coating 24 is passed through each metal pipe 31.

### (Configuration of Metal Fixing Member 32)

The metal fixing member 32 is made of a plate material. In particular, the metal fixing member 32 is configured, such as by stamping the metal plate material.

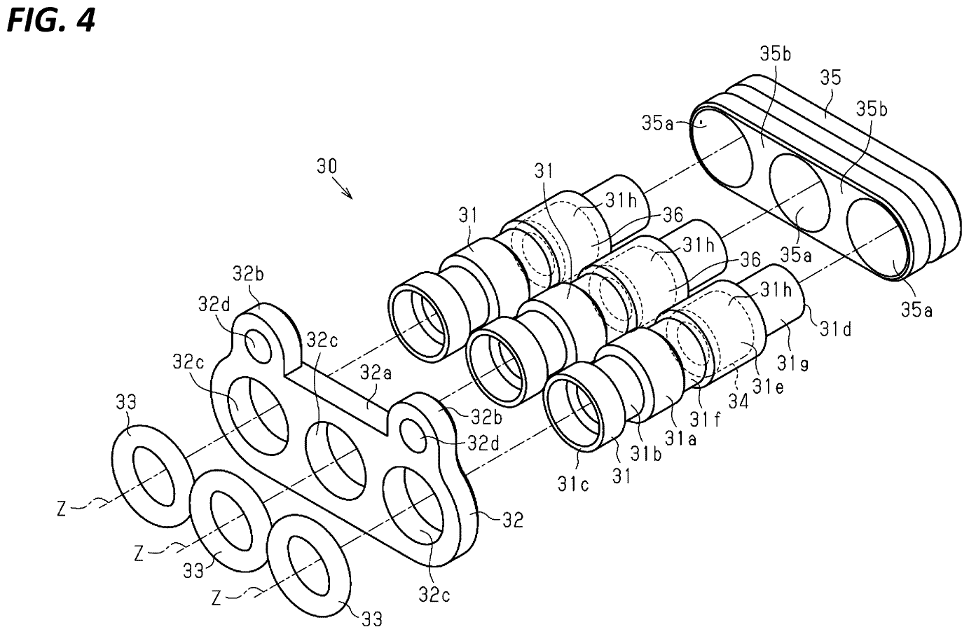

As shown in FIG. 4, the metal fixing member 32 includes a body portion 32a having a rectangular shape when viewed from a plate thickness direction and fixing portions 32b projecting in a short-side direction from both end sides in a longitudinal direction of the body portion 32a. The metal fixing member 32 includes pipe fixing holes 32c penetrating in the plate thickness direction. Three pipe fixing holes 32c are formed in the body portion 32a. The three pipe fixing holes 32c are provided side by side at equal intervals along the longitudinal direction of the body portion 32a. Note that an unevenness processing such as knurling is preferably applied to the inner surface of the pipe fixing hole 32c. Further, the metal fixing member 32 includes connector mounting holes 32d penetrating in the plate thickness direction. The connector mounting hole 32d is formed in each of the two fixing portions 32b.

### (Configuration of Metal Pipe 31)

The metal pipe 31 is made of a pipe material. In Particular, the metal pipe 31 is configured, such as by applying a pipe expansion processing of expanding a diameter or a pipe contraction processing of reducing the diameter to the pipe material having a constant diameter and made of metal.

As shown in FIG. 2, the metal pipe 31 includes a first pipe expansion portion 31a to be coupled to the inner surface of the pipe fixing hole 32c. The first pipe expansion portion 31a is a part expanded to have a larger diameter than adjacent parts in a length direction in the metal pipe 31. The first pipe expansion portion 31a is provided in an intermediate part of the metal pipe 31. The metal pipe 31 is fixed to the metal fixing member 32 by pressing the first pipe expansion portion 31a into contact with and coupled to the inner surface of the pipe fixing hole 32c when the first pipe expansion portion 31a is formed by the pipe expansion processing. In other words, the metal fixing member 32 is fixed to the metal pipe 31 by expanding the metal pipe 31 in the pipe fixing hole 32c to form the first pipe expansion portion 31a.

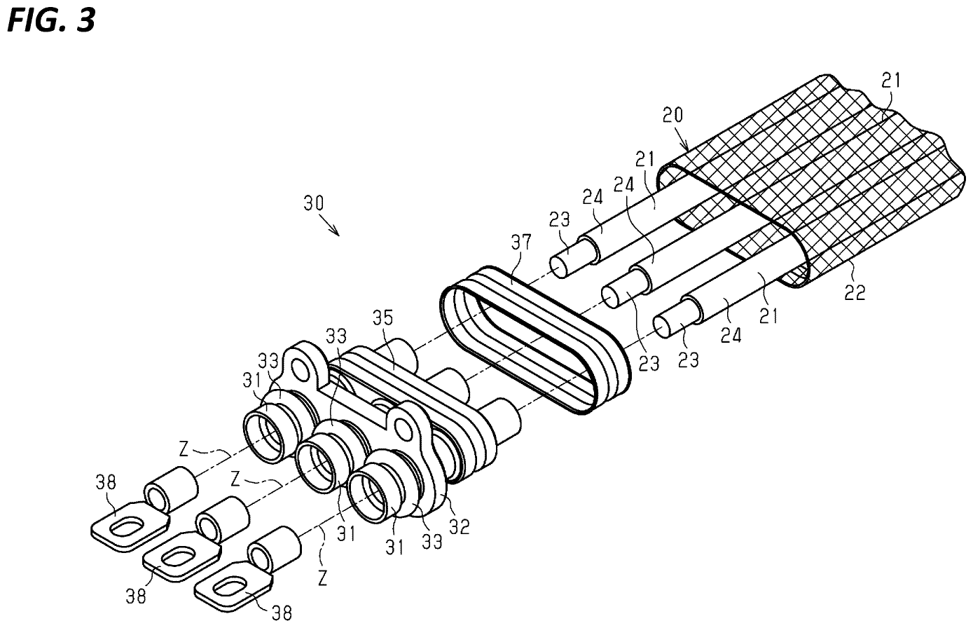

As shown in FIGS. 3 and 4, the metal fixing member 32 is so fixed to a plurality of the metal pipes 31 that axes Z of the plurality of metal pipes 31 are parallel to each other. Note that FIG. 4 is not an exploded perspective view of a state before the metal pipes 31 and the metal fixing member 32 are fixed, but shows the metal pipes 31 including the first pipe expansion portions 31a in a state where the metal pipes 31 and the metal fixing member 32 are disassembled again after being once fixed.

Further, the metal pipe 31 includes a first pipe contraction portion 31b. The first pipe contraction portion 31b is a part contracted to have a smaller diameter than adjacent parts in the length direction in the metal pipe 31. The first pipe contraction portion 31b is provided on a side closer to the tip of the metal pipe 31 than the first pipe expansion portion 31a. In particular, the metal pipe 31 includes a first end part 31c arranged on a tip side of the wiring harness 10 and a second end part 31d arranged on an intermediate side of the wiring harness 10. The first pipe contraction portion 31b is provided on a side closer to the first end part 31c than the first pipe expansion portion 31a.

The connector 30 is provided with first rubber rings 33 to be externally fit to the metal pipes 31. The first rubber ring 33 is externally fit to the first pipe contraction portion 31b.

Further, the metal pipe 31 includes a second pipe expansion portion 31e. The second pipe expansion portion 31e is a part expanded to have a larger diameter than adjacent parts in the length direction in the metal pipe 31. The second pipe expansion portion 31e is provided on a side closer to the second end part 31d than the first pipe expansion portion 31a while being spaced apart from the first pipe expansion portion 31a. Note that a basis portion 31f maintained to have a diameter of the pipe material constituting the metal pipe 31 without the pipe expansion processing or the pipe contraction processing being applied thereto is provided between the first and second pipe expansion portions 31a, 31b.

The connector 30 is provided with second rubber rings 34 to be fit into the metal pipes 31. The second rubber ring 34 is fit into the second pipe expansion portion 31e.

The wire 21 is inserted through the metal pipe 31. With the wire 21 inserted through the metal pipe 31, the second rubber ring 34 is interposed in a compressed state between the outer peripheral surface of the insulation coating 24 and the inner peripheral surface of the metal pipe 31.

Further, the metal pipe 31 includes a second pipe contraction portion 31g. The second pipe contraction portion 31g is a part contracted to have a smaller diameter than adjacent parts in the length direction in the metal pipe 31. The second pipe contraction portion 31g is provided on the second end part 31d. The metal pipe 31 is fixed to the wire 21 by pressing the second pipe contraction portion 31g into contact with the insulation coating 24.

As shown in FIGS. 3 and 4, the connector 30 is provided with a connecting member 35. As shown in FIG. 4, the connecting member 35 includes three through holes 35a, into which the metal pipes 31 are respectively fit. The through hole 35a is formed in such a size that the second pipe expansion portion 31e of the metal pipe 31 is fit thereinto. The connecting member 35 is provided to fill up gaps 36 between the outer peripheral surfaces 31h of the three metal pipes 31 while covering the three metal pipes 31. In particular, the connecting member 35 is provided to fill up the gaps 36 between the outer peripheral surfaces 31h of the second pipe expansion portions 31e in the three metal pipes 31 while covering the second pipe expansion portions 31e of the three metal pipes 31. That is, the connecting member 35 fills up the gaps 36 formed between the outer peripheral surfaces 31h of the metal pipes 31 by coupling parts 35b between the through holes 35a.

As shown in FIG. 2, the shield member 22 is connected to the outer peripheral surface of the connecting member 35. In particular, the wiring harness 10 is provided with a crimping member 37. The shield member 22 is arranged to cover the outer peripheral surface of the connecting member 35 and, further, connected to the connecting member 35 by crimping the crimping member 37 to the outside of the shield member 22. That is, the connecting member 35 contacts the shield member 22 over an entire periphery while serving as a base when the crimping member 37 is crimped. The crimping member 37 fixes the shield member 22 to the connecting member 35 by being crimped. Note that the crimping member 37 of this embodiment is a crimp ring made of metal and formed into an annular shape. The shield member 22 is electrically connected to the metal pipes 31 via the connecting member 35.

Further, an end part of the core wire 23 is exposed to outside from the first end part 31c of the metal pipe 31 and exposed from the insulation coating 24. A terminal 38 is crimped and fixed to the end part of the core wire 23.

### (Configuration of Housing 50 of Electrical Device and Fixing Structure of Connector 30)

As shown in FIG. 2, the housing 50 of the electrical device serving as the mounting object is provided with mounting holes 50a and fastening portions 50b. The housing 50 of the electrical device is made of metal. The connector 30 is so fixed to the housing 50 of the electrical device that the terminals 38 and the sides of the first end parts 31c of the metal pipes 31 are inserted in the mounting holes 50a.

With the sides of the first end parts 31c of the metal pipes 31 inserted in the mounting holes 50a, the first rubber rings 33 are interposed in a compressed state between the outer peripheral surfaces of the metal pipes 31 and the inner peripheral surfaces of the mounting holes 50a. The connector 30 is fixed to the housing 50 of the electrical device by bolts 39 threadably engaged with the fastening portions 50b through the connector mounting holes 32d. In this way, the shield member 22 is electrically connected to the housing 50 of the electrical device via the connector 30. With the connector 30 fixed to the housing 50 of the electrical device, unillustrated terminals of the electrical device are connected to the terminals 38.

Next, functions of the wiring harness 10 configured as described above are described.

In the multi-core collective shielded cable 20, the insulation coatings 24 of the plurality of wires 21 are collectively covered by the shield member 22. Thus, the emission of electromagnetic waves from the cores 23 in parts covered by the shield member 22 is suppressed. Further, the shield member 22 is electrically connected to the housing 50 of the electrical device by fixing the connector 30 to the housing 50 of the electrical device. In the connector 30, the wires 21 are covered by the metal pipes 31. Thus, the emission of electromagnetic waves from parts of the core wires 23 in the connector 30 is suppressed.

Next, effects of the above embodiment are described below.

(1) In the connector 30, the core wires 23 are covered by the metal pipes 31. Further, the shield member 22 is connected to the housing 50 of the electrical device via the metal pipes 31 and the metal fixing member 32. Thus, the emission of electromagnetic waves from the core wires 23 can be suppressed. Since the metal pipes 31 and the metal fixing member 32 are separate bodies and fixed to each other after manufacturing, each of these can be easily obtained. The connector 30 of the embodiment does not require a resin molded article such as a resin housing provided in conventional connectors and, consequently, a mold for molding this resin molded article is also not required. Therefore, the connector 30 of the embodiment can be easily manufactured.

(2) The metal fixing member 32 is made of the plate material. Thus, the metal fixing member 32 can be more easily manufactured, for example, as compared to a cast.

(3) The metal pipe 31 includes the first pipe expansion processing 31a to be coupled to the inner surface of the pipe fixing hole 32c, and can be coupled to the inner surface of the pipe fixing hole 32c by applying the pipe expansion processing to the metal pipe 31. Thus, a fixing operation is easier, for example, as compared to welding.

(4) The first rubber rings 33 are provided which are externally fit to the metal pipes 31. Thus, by interposing the first rubber ring 33 between the outer peripheral surface of the metal pipe 31 and the inner peripheral surface of the mounting hole 50a in the housing 50 of the electrical device, this part can be waterproofed. Since the first rubber rings 33 can have a simple shape without needing any special shape and can be assembled by being externally fit to the metal pipes 31, the connector 30 can be easily manufactured.

(5) The metal pipe 31 includes the first pipe contraction portion 31b, to which the first rubber ring 33 is externally fit. Thus, a position shift of the first rubber ring 33 along the length direction of the metal pipe 31 is suppressed.

(6) The second rubber ring 34 is provided which is fit into the metal pipe 31. Thus, by interposing the second rubber ring 34 between the inner peripheral surface of the metal pipe 31 and the outer peripheral surface of the insulation coating 24, this part can be waterproofed. Since the second rubber rings 34 can have a simple shape without needing any special shape and can be assembled by being fit into the metal pipes 31, the connector 30 can be easily manufactured.

(7) The metal pipe 31 includes the second pipe expansion portion 31e, into which the second rubber ring 34 is fit. Thus, a position shift of the second rubber ring 34 along the length direction of the metal pipe 31 is suppressed.

(8) The metal pipe 31 includes the second pipe contraction portion 31g to be pressed into contact with the insulation coating 24. Thus, the insulation coating 24 and the connector 30 can be fixed by the second pipe contraction portion 31g without using a separate member.

(9) The connecting member 35 is provided which fills up the gaps 36 between the outer peripheral surfaces 31h of the plurality of metal pipes 31 and to which the shield member 22 is connected. Thus, the shield member 22 in the multi-core collective shielded cable 20 can be satisfactorily electrically connected to the metal pipes 31. That is, in a configuration in which the connecting member 35 is not provided, a contact area is small since the shield member 22 is not in contact with or difficult to contact the plurality of metal pipes 31 in the gaps 36 between the outer peripheral surfaces 31h of the plurality of metal pipes 31. However, this can be avoided in the above configuration. Therefore, the shield member 22 can be satisfactorily connected to the metal pipes 31.

(10) The connecting member 35 is provided to fill up the gaps 36 between the outer peripheral surfaces 31h of the second pipe expansion portions 31e in the metal pipes 31. Since the gaps 36 between the outer peripheral surfaces 31h of the second pipe expansion portions 31e are smaller than gaps between the outer peripheral surfaces of other parts, to which the pipe expansion processing is not applied, the material cost of the connecting member 35 provided to fill up the gaps 36 can be reduced.

(11) The shield member 22 can be easily connected to the connecting member 35 by the crimping member 37.

This embodiment can be modified and carried out as follows. This embodiment and the following modifications can be carried out in combination with technically contradicting each other.
Although the metal fixing member 32 is made of the plate material in the above embodiment, there is no limitation to this and the metal fixing member 32 may be a cast or the like formed using a mold. Further, although the metal fixing member 32 is configured such as by stamping the metal plate material, another processing such as bending may be applied while the metal fixing member 32 is made of the plate material.
Although the metal pipe 31 includes the first pipe expansion portion 31a to be coupled to the inner surface of the pipe fixing hole 32c in the above embodiment, there is no limitation to this and the first pipe expansion portion 31a may not be provided. For example, a metal pipe and a metal fixing member may be fixed by welding.
Although the connector 30 is provided with the first rubber rings 33 to be externally fit to the metal pipes 31 in the above embodiment, there is no limitation to this and the first rubber rings 33 may not be provided. For example, a sealing member may be fixed to the metal fixing member 32 by adhesion or the like instead of using the first rubber rings 33.
Although the metal pipe 31 includes the first pipe contraction portion 31b, to which the first rubber ring 33 is externally fit, in the above embodiment, there is no limitation to this and the first pipe contraction portion 31b may not be provided.
Although the connector 30 is provided with the second rubber rings 34 to be fit into the metal pipes 31 in the above embodiment, there is no limitation to this and the second rubber rings 34 may not be provided. For example, a sealing member may be fixed to the second end parts 31d of the metal pipes 31 by adhesion or the like instead of using the second rubber rings 34.
Although the metal pipe 31 includes the second pipe expansion portion 31e, into which the second rubber ring 34 is fit, in the above embodiment, there is no limitation to this and the second pipe expansion portion 31e may not be provided. Further, the first pipe expansion portion 31a may be used as a second pipe expansion portion without independently forming the second pipe expansion portion 31e and the second rubber ring 34 may be fit into the first pipe expansion portion 31e constituting the second pipe expansion portion.
Although the metal pipe 31 includes the second pipe contraction portion 31g to be pressed into contact with the insulation coating 24 in the above embodiment, there is no limitation to this and the second pipe contraction portion 31g may not be provided. For example, the insulation coating 24 and, consequently, the wire 21 may be fixed to the metal pipe 31 by another member.
Although the connector 30 includes the connecting member 35 in the above embodiment, there is no limitation to this and the connecting member 35 may not be provided. Particularly, since the shielded cable is the multi-core collective shielded cable 20 in the above embodiment, the connecting member 35 is provided to satisfactorily electrically connect the shield member 22 to the metal pipes 31. However, the connecting member 35 is unnecessary in a configuration in which an independent shield member is provided for each wire 21. That is, in a configuration in which the shielded cable is each core shielded cable and the independent shield member is provided for each wire 21, each shield member may be directly connected to each metal pipe 31.
Although the connecting member 35 is provided to fill up the gaps 36 between the outer peripheral surfaces 31h of the second pipe expansion portions 31e in the above embodiment, there is no limitation to this and the connecting member 35 may be provided to fill up gaps between the outer peripheral surfaces of parts of the metal pipes 31 other than the second pipe expansion portions 31e.
Although the crimping member 37 is provided in the above embodiment, there is no limitation to this. For example, the shield member 22 may be fixed to the connecting member 35 by welding without providing the crimping member 37.
Although the multi-core collective shielded cable 20 includes the three wires 21 and the connector 30 is provided with the three metal pipes 31 in the above embodiment, there is no limitation to this and the number of the wires 21 and the number of the metal pipes 31 may be changed to another number.
The metal pipes 31 and the metal fixing member 32 may be configured as separate bodies and the metal pipes 31 and the metal fixing member 32 may be fixed by crimping the outer peripheral surfaces of the metal pipes 31 to the inner surfaces of the pipe fixing holes 32c of the metal fixing members 32.
The connecting member 35 may be an electrically conductive member for electrically connecting the metal pipes 31 and the shield member 22. The connecting member 35 may have an inner peripheral surface to be brought into direct contact with the outer peripheral surfaces of the metal pipes 31. The connecting member 35 may have an outer peripheral surface to be brought into direct contact with the inner peripheral surface of the shield member 22.
As shown in FIG. 2, the first pipe contraction portion 31b of the metal pipe 31 can form a step for suppressing a position shift of the first rubber ring 33 along the length direction of the metal pipe 31 toward the first end part 31c. The first rubber ring 33 externally fit to the first pipe contraction portion 31b may project more radially outward of the metal pipe 31 than the first pipe expansion portion 31a and the first end part 31c of the metal pipe 31.
A connector (30) according to several embodiments of the present disclosure may be configured to be used together with an electrical device including a metal housing (50) including a mounting hole (50a) configured to receive a part of the connector (30) and an electrically conductive connector receiving surface to be brought into contact with another part of the connector (30), and may be provided with: a metal fixing member (32) including a pipe fixing hole (32c) to be aligned with the mounting hole (50a) of the metal housing (50), the metal fixing member (32) being fixed to the electrically conductive connector receiving surface of the metal housing (50); a shielded cable (20) including an electrically conductive core wire (23) having a tip part, an insulation coating (24) covering the core wire (23) in such a manner as to expose the tip part of the core wire (23) and an electrically conductive shield member (22) for exposing the tip part of the core wire (23) and covering the insulation coating (24) in such a manner as to expose one end part of the insulation coating (24); and a metal pipe (31) for allowing the passage of the shielded cable (20) therethrough, the metal pipe (31) including a first length part, which can be the second pipe contraction portion (31g) of the embodiment, a second length part, which can be the second pipe expansion portion (31e) of the embodiment, a third length part, which can be the first pipe expansion portion (31a) of the embodiment, and a fourth length part, which can be the first pipe contraction portion (31b) of the embodiment, the first length part of the metal pipe (31) may be configured to contact or face the outer peripheral surface of the insulation coating (24) of the shielded cable (20) and be surrounded by the shield member (22) of the shielded cable (20), the second length part of the metal pipe (31) may be configured to be electrically connected to the inner peripheral surface of the shield member (22), the third length part of the metal pipe (31) may be configured to directly contact and be electrically connected to the pipe fitting hole (32c) of the metal fixing member (32), and the fourth length part of the metal pipe (31) may be configured to be received into the mounting hole (50a) of the metal housing (50).
In several embodiments of the present disclosure, the third length part of the metal pipe (31) may be directly in contact with or fixed to the pipe fitting hole (32c) of the metal fixing member (32) so that the metal pipe (31) does not move in a length direction with respect to the metal fixing member (32).
In several embodiments of the present disclosure, the metal pipe (31) may be a metal one-piece product having openings on both ends.

### LIST OF REFERENCE NUMERALS

10 wiring harness
20 multi-core collective shielded cable (shielded cable)
21 wire
22 shield member
23 core wire
24 insulation coating
30 connector
31 metal pipe
31a first pipe expansion portion
31b first pipe contraction portion
31c first end part
31d second end part
31e second pipe expansion portion
31f basis portion
31g second pipe contraction portion
31h outer peripheral surface
32 metal fixing member
32a body portion
32b fixing portion
32c pipe fitting hole
32d connector mounting hole
33 first rubber ring
34 second rubber ring
35 connecting member
35a through hole
35b coupling part
36 gap
37 crimping member
38 terminal
39 bolt
50 housing of electrical device (mounting object)
50a mounting hole
50b fastening portion
Z axis

1. A connector for electrically connecting a shield member to a mounting object by being fixed to an end part of a shielded cable including a core wire, an insulation coating covering an outer periphery of the core wire and the shield member for covering an outer periphery of the insulation coating and fixed to the mounting object, comprising:
a metal pipe, the core wire and the insulation coating being passed through the metal pipe, the shield member being connected to the metal pipe; and
a metal fixing member to be fixed to an outer peripheral surface of the metal pipe and fixed to the mounting object.

2. The connector of claim 1, wherein the metal fixing member is made of a plate material.

3. The connector of claim 1, wherein:
the metal fixing member includes a pipe fitting hole, and
the metal pipe includes a first pipe expansion portion to be coupled to an inner surface of the pipe fitting hole.

4. The connector of claim 1, comprising a first rubber ring to be externally fit to the metal pipe.

5. The connector of claim 4, wherein the metal pipe includes a first pipe contraction portion, the first rubber ring being externally fit to the first pipe contraction portion.

6. The connector of claim 1, comprising a second rubber ring to be fit into the metal pipe.

7. The connector of claim 6, wherein the metal pipe includes a second pipe expansion portion, the second rubber ring being fit into the second pipe contraction portion.

8. The connector of claim 1, wherein the metal pipe includes a second pipe contraction portion to be pressed into contact with the insulation coating.

9. The connector of claim 1, wherein:
the shielded cable is a multi-core collective shielded cable including a plurality of the core wires and a plurality of the insulation coatings, the shield member collectively covering the plurality of insulation coatings,
a plurality of the metal pipes are provided, a set of the core wire and the insulation coating being passed through each metal pipe,
the metal fixing member is so fixed to at least one of the plurality of metal pipes that axes of the plurality of metal pipes are parallel to each other, and
a connecting member is provided to fill up gaps between outer peripheral surfaces of the plurality of metal pipes, the shield member being connected to the connecting member.

10. The connector of claim 7, wherein:
the shielded cable is a multi-core collective shielded cable including a plurality of the core wires and a plurality of the insulation coatings, the shield member collectively covering the plurality of insulation coatings,
a plurality of the metal pipes are provided, a set of the core wire and the insulation coating being passed through each metal pipe,
the metal fixing member is so fixed to at least one of the plurality of metal pipes that axes of the plurality of metal pipes are parallel to each other, and
a connecting member is provided to fill up gaps between outer peripheral surfaces of the second pipe expansion portions in the plurality of metal pipes, the shield member being connected to the connecting member.

11. A wiring harness, comprising:
the connector of claim 1; and
the shielded cable.

12. A wiring harness, comprising:
the connector of claim 9;
the shielded cable; and
a crimping member for fixing the shield member to the connecting member by being crimped.
